(19) United States
(12) Patent Application Publication
(10) Pub. No.: US 2012/0152470 A1
(43) Pub. Date: Jun. 21, 2012

(54) DECELERATING DEVICE INTEGRATED WITH BLIND STRUCTURE

(75) Inventor: Ju-Huai Chen, Changhua County (TW)

(73) Assignee: CHICOLOGY, INC., Ontario (CA)

(21) Appl. No.: 12/969,243

(22) Filed: Dec. 15, 2010

(51) Int. Cl. E06B 9/80; F16F 9/12

(52) U.S. Cl. 160/292; 188/290

(57) ABSTRACT

A decelerating device integrated with a blind structure includes a blind structure comprising a batten and a blind fabric disposed at the batten; a first decelerating unit disposed at an end of the batten; a winding unit coupled to an end of the first decelerating unit and disposed in the batten; and a second decelerating unit disposed at another end of the batten. The decelerating device prevents window blind damage and promotes user safety by precluding instantaneous upward winding of a blind fabric, as precluding instantaneous upward winding of the blind fabric follows increasing winding-induced resistance by first and second decelerating units while a batten is winding in the blind fabric by means of a winding mechanism.

### FIELD OF THE INVENTION

The present invention relates to decelerating devices each integrated with a window blind structure, and more particularly, to a decelerating device integrated with a blind structure and configured to prevent window blind damage and promote user safety by precluding instantaneous upward winding of a blind fabric, as precluding instantaneous upward winding of the blind fabric follows increasing winding-induced resistance by first and second decelerating units while a batten is winding in the blind fabric by means of a winding mechanism.

### BACKGROUND OF THE INVENTION

In general, a conventional window blind structure comprises a blind rod, an elevating unit, a blind fabric connected to the bottom of the blind rod, and an automatic winding mechanism disposed in the blind rod and connected to the blind fabric, to thereby wind in the blind fabric by automation.

With the automatic winding mechanism being unstoppable, the automatic winding mechanism produces a strong instantaneous winding force while winding in the blind fabric, and thus the conventional window blind structure is likely to be damaged due to an excessive impact.

To prevent the aforesaid drawback of the prior art, related blind manufacturers developed various decelerating mechanisms for precluding instantaneous upward winding. Nonetheless, each of the commercially available decelerating mechanisms has to be coupled to the automatic winding mechanism in order to work in conjunction therewith. As a result, the automatic winding mechanism is useless for an existing window blind structure which is not equipped with a decelerating mechanism. Due to the aforesaid limitation of application, window blind users have to take apart a window blind structure in use in order to overcome the problem with instantaneous upward winding while making good use of the commercially available decelerating mechanisms, albeit at the cost of a lack of universality and a waste of resources.

Accordingly, it is imperative to invent a decelerating structure configured integrated with a blind and capable of precluding instantaneous upward of a blind fabric, so as to prevent window blind damage and promote user safety.

### SUMMARY OF THE INVENTION

In view of the shortcomings of conventional decelerating devices integrated with a blind structure, the inventor of the present invention understands the prior art has room for improvement, conducted extensive researches and experiments according to the inventor's years of experience in the related industry, and finally developed a decelerating device integrated with a blind structure as disclosed in the present invention with a view to precluding instantaneous upward of a blind fabric, preventing window blind damage, and promoting user safety.

It is a primary objective of the present invention to provide a decelerating device integrated with a blind structure and configured to prevent window blind damage and promote user safety by precluding instantaneous upward winding of a blind fabric, as precluding instantaneous upward winding of the blind fabric follows increasing winding-induced resistance by first and second decelerating units while a batten is winding in the blind fabric by means of a winding mechanism.

In order to achieve the above and other objectives, the present invention provides a decelerating device integrated with a blind structure. The decelerating device comprises: a blind structure comprising a batten and a blind fabric disposed at the batten; a first decelerating unit disposed at an end of the batten; a winding unit coupled to an end of the first decelerating unit and disposed in the batten; and a second decelerating unit disposed at another end of the batten.

In an embodiment of the present invention, the first decelerating unit comprises: a housing; a lid coupled to the housing; a sliding groove disposed on an inner wall surface of the housing; a bushing disposed in the housing; a guiding groove disposed on an outer surface of the bushing; a ball movably disposed between the sliding groove and the guiding groove; a spindle penetrating the bushing, having an end protruding from the housing, and being coupled to the winding unit; and a resilient element disposed around the spindle and having an end coupled to the bushing.

In an embodiment of the present invention, a working oil having a damping effect is filled between the sliding groove and the guiding groove.

In an embodiment of the present invention, a positioning member is disposed at another end of the spindle and configured to protrude from the lid.

In an embodiment of the present invention, the winding unit comprises: a connecting rod coupled to an end of the first decelerating unit, a spring disposed around the connecting rod, and a stopping member disposed at an end of the connecting rod.

In an embodiment of the present invention, the second decelerating unit comprises: an outer sleeve; an inner sleeve disposed in the outer sleeve; an axle penetrating the outer and inner sleeves and protruding therefrom in lengthwise opposite directions; a resilient unit disposed around the axle and having an end coupled to the inner sleeve; and a stopping element disposed at one end of the axle, wherein the stopping element-disposed end of the axle protrudes from the inner sleeve.

In an embodiment of the present invention, a positioning member is disposed at another end of the axle, wherein the positioning member-disposed end of the axle protrudes from the outer sleeve.

In an embodiment of the present invention, a working oil having a damping effect is filled between the outer sleeve and the inner sleeve.

Accordingly, as disclosed in the present invention, a decelerating device integrated with a blind structure is effective in preventing window blind damage and promoting user safety by precluding instantaneous upward winding of a blind fabric, as precluding instantaneous upward winding of the blind fabric follows increasing winding-induced resistance by first and second decelerating units while a batten is winding in the blind fabric by means of a winding mechanism.

### BRIEF DESCRIPTION OF THE DRAWINGS

A detailed description of further features and advantages of the present invention is given below so that a person skilled in the art can understand and implement the technical contents of the present invention and readily comprehend the objectives, features, and advantages thereof by reviewing the disclosure of the present specification and the appended claims in conjunction with the accompanying drawings, in which:

FIG. 1 is a perspective view of a decelerating device integrated with a blind structure according to a preferred embodiment of the present invention;

FIG. 2 is an exploded view of the decelerating device according to a preferred embodiment of the present invention;

FIG. 3 is an exploded view of a first decelerating unit according to the present invention;

FIG. 4 is an exploded view of a second decelerating unit according to the present invention; and

FIG. 5 is a cross-sectional view taken along line A-A shown in FIG. 1 according to the present invention.

### DETAILED DESCRIPTION OF THE PREFERRED EMBODIMENTS

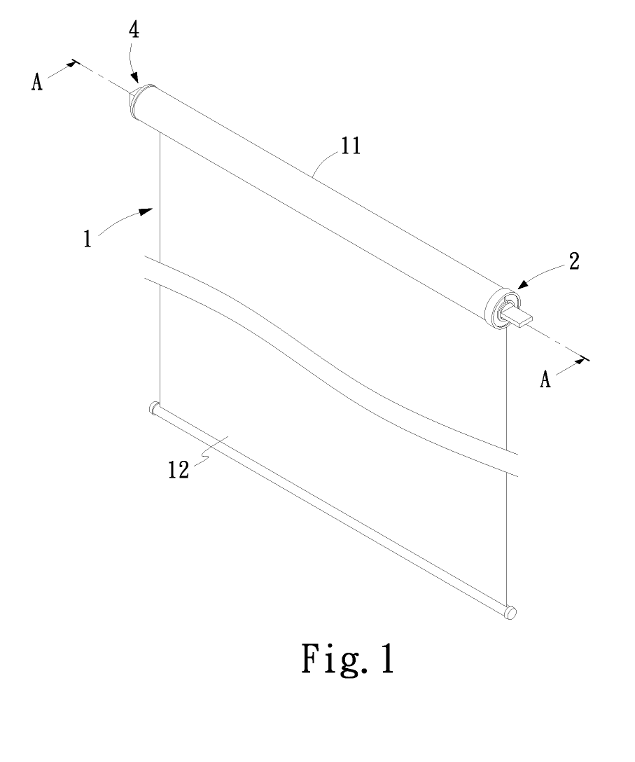

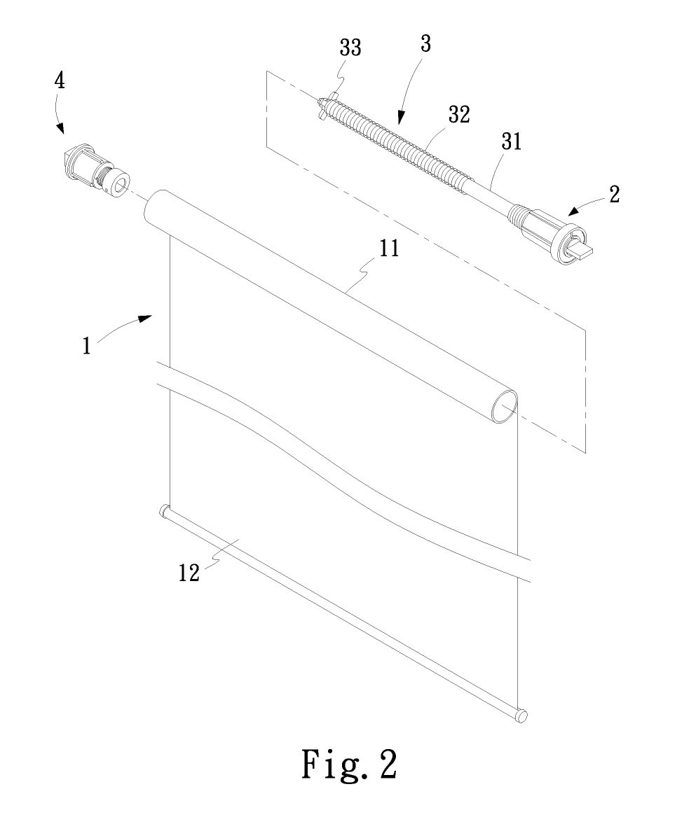

The present invention provides a decelerating device integrated with a blind structure. Referring to FIG. 1 and FIG. 2, there are shown a perspective view and an exploded view of a decelerating device integrated with a blind structure according to a preferred embodiment of the present invention, respectively. As shown in the drawings, the decelerating device comprises a blind structure 1, a first decelerating unit 2, a winding unit 3, and a second decelerating unit 4.

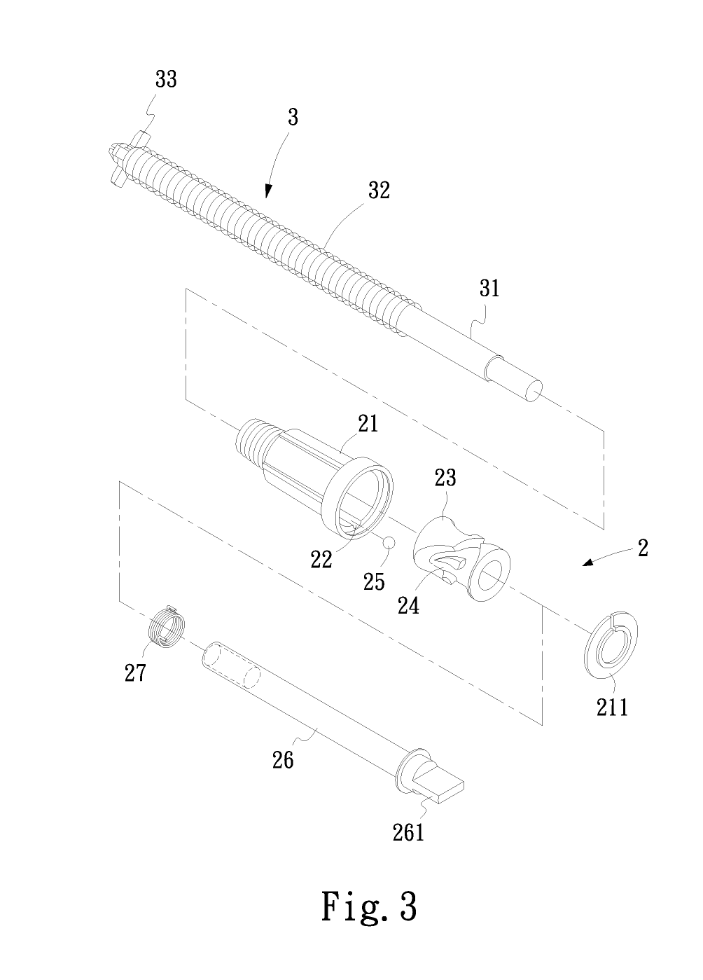

The blind structure 1 comprises a batten 11 and a blind fabric 12 disposed at the batten 11. Referring to FIG. 3, there is shown an exploded view of the first decelerating unit 2 according to the present invention. As shown in the drawing, the first decelerating unit 2 is disposed at an end of the batten 11. The first decelerating unit 2 comprises: a housing 21; a lid 211 coupled to the housing 21; a sliding groove 22 disposed on an inner wall surface of the housing 21; a bushing 23 disposed in the housing 21; a guiding groove 24 disposed on an outer surface of the bushing 23; a ball 25 movably disposed between the sliding groove 22 and the guiding groove 24; a spindle 26 penetrating the bushing 23 and having one end protruding from the housing 21; and a resilient element 27 disposed around the spindle 26 and having one end coupled to the bushing 23. A working oil having a damping effect is filled between the sliding groove 22 and the guiding groove 24. A positioning member 261 is disposed at the other end of the spindle 26 and configured to protrude from the lid 211.

The winding unit 3 is coupled to one end of the first decelerating unit 2 and disposed inside the batten 11. The winding unit 3 comprises: a connecting rod 31 coupled to one end of the spindle 26, a spring 32 disposed around the connecting rod 31, and a stopping member 33 disposed at one end of the connecting rod 31. One end of the spring 32 corresponds in position to the stopping member-disposed end of the connecting rod 31 and abuts against the stopping member 33.

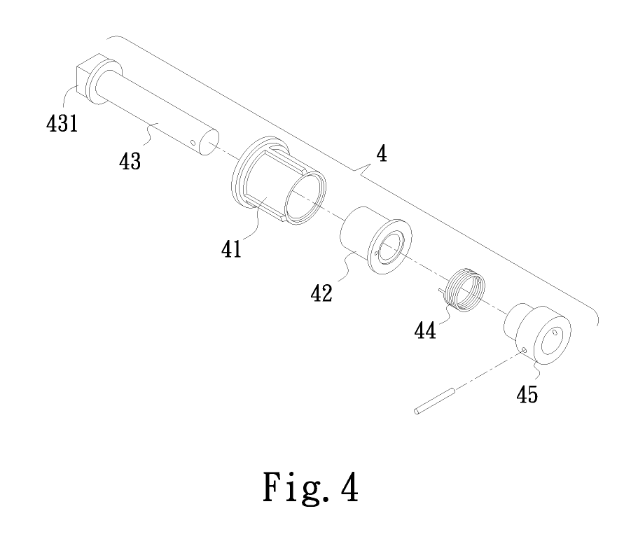

Referring to FIG. 4, there is shown an exploded view of the second decelerating unit 4 according to the present invention. As shown in the drawing, the second decelerating unit 4 is disposed at another end of the batten 11, and comprises: an outer sleeve 41; an inner sleeve 42 disposed in the outer sleeve 41; an axle 43 penetrating the outer and inner sleeves 41, 42 and protruding therefrom in lengthwise opposite directions; a resilient unit 44 disposed around the axle 43 and having an end coupled to the inner sleeve 42; and a stopping element 45 disposed at one end of the axle 43, wherein the stopping element-disposed end of the axle 43 protrudes from the inner sleeve 42. A positioning member 431 is disposed at the other end of the axle 43, wherein the positioning member-disposed end of the axle 43 protrudes from the outer sleeve 41. A working oil having a damping effect is filled between the outer sleeve 41 and the inner sleeve 42.

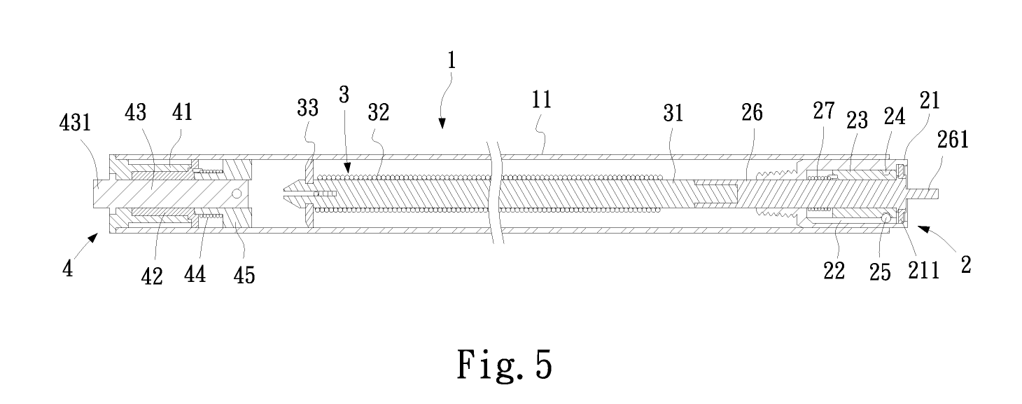

Referring to FIG. 5, there is shown a cross-sectional view taken along line A-A shown in FIG. 1 according to the present invention. As shown in the FIGS. 1 and 5, to start implementing the present invention, a user fixes the blind structure 1 in place between two end holders (not shown) by means of the positioning members 261, 431 disposed at the first decelerating unit 2 and the second decelerating unit 4, respectively, and then fixes the end holders in place, so as to finish the installation of the blind structure 1.

To start using the decelerating device, the user gives a pull at the blind fabric 12 of the blind structure 1 and thus enables the blind fabric 12 to drive the batten 11 to rotate; meanwhile, the batten 11 drives the housing 21 of the first decelerating unit 2 to rotate. The housing 21 rotates relative to the bushing 23 because of the coordinated operation of the sliding groove 22, the ball 25, and the guiding groove 24. The descent of the blind fabric 12 also causes the housing 21 to loosen the spring 32 of the winding unit 3. Once the blind fabric 12 lowers to an appropriate level, the user may release the blind fabric 12 and allow the housing 21 to drive the spindle 26 to rotate backward slightly. The slight reverse rotation of the spindle 26 is accompanied by the compression of the resilient element 27 having one end coupled to the bushing 23, and thus the blind fabric 12 is fixed in place as appropriate. Furthermore, to wind in the blind fabric 12, the user gives a slight downward pull at the blind fabric 12 and therefore loosens the resilient element 27 disposed around the spindle 26; meanwhile, the resilience of the spring 32 of the winding unit 3 is restored. Hence, the housing 21 rotates reversely relative to the bushing 23 because of the coordinated operation of the sliding groove 22, the ball 25, and the guiding groove 24. The reverse rotation of the housing 21 has an immediate effect upon the second decelerating unit 4, that is, the outer sleeve 41 rotates relative to the inner sleeve 42. The rotation of the outer sleeve 41 relative to the inner sleeve 42, coupled with the damping effect of the working oil filled between the outer and inner sleeve 41, 42 of the resilient unit 44 and the working oil filled between the sliding groove 22 and the guiding groove 24, increases the resistance to the winding of the blind fabric 12, and thus the blind fabric 12 is slowly wound upward. In addition, grasping the blind fabric 12 followed by giving a downward pull thereto in the course of the upward winding thereof offsets an upward force exerted by the winding unit 3 and thereby stops the winding of the blind fabric 12, and in consequence the blind fabric 12 is positioned at a predetermined level. The upward winding of the blind fabric 12 resumes as soon as a pull is given to the blind fabric 12 again. In so doing, the blind fabric 12 is prevented from being instantaneously wound upward under a rebounding force of the winding unit 3. The immediate motion-related advantages of the decelerating device is as follows: the blind fabric upon which a downward force greater than or equal to an upward winding force is exerted stands still temporarily rather than be wound upward. The upward winding of the blind fabric resumes, albeit slowly, as soon as the downward force decreases to less than the upward winding force. The blind fabric will not be stationary thoroughly, unless the downward force greater than the upward winding force is applied once again, thereby protecting the window blind against damage and enhancing user safety. The present invention also applies to heavy blind fabrics and large-sized window blinds. It is because large-sized window blinds are always too heavy to enable uniform distribution of weight or are susceptible to resilience fatigue. The present invention overcomes two drawbacks of conventional window blinds. First, an excessive rebounding force causes instantaneous rapid upward winding of a blind fabric in response to a downward pull given to the blind fabric. Second, the blind fabric comes to a halt whenever the downward pull is greater than or equal to the upward pull. The second drawback is often present in the situation where a window blind has been in use for a long while and thus a spring therein manifests resilience fatigue.

Hence, the present invention meets the three requirements of patentability, namely novelty, non-obviousness, and industrial applicability. Regarding novelty and non-obviousness, the present invention discloses the decelerating device for preventing window blind damage and promoting user safety by precluding instantaneous upward winding of a blind fabric, as precluding instantaneous upward winding of the blind fabric follows increasing winding-induced resistance by first and second decelerating units while a batten is winding in the blind fabric by means of a winding mechanism. Regarding industrial applicability, products derived from the present invention meet market demands fully.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and replacements made to the foregoing embodiments should fall within the scope of the present invention as set forth in the appended claims. Accordingly, the protection for the present invention should be defined by the appended claims.

What is claimed is:

1. A decelerating device integrated with a blind structure, the decelerating device comprising:
a blind structure comprising a batten and a blind fabric disposed at the batten;
a first decelerating unit disposed at an end of the batten;
a winding unit coupled to an end of the first decelerating unit and disposed in the batten; and
a second decelerating unit disposed at another end of the batten.

2. The decelerating device of claim 1, wherein the first decelerating unit comprises: a housing; a lid coupled to the housing; a sliding groove disposed on an inner wall surface of the housing; a bushing disposed in the housing; a guiding groove disposed on an outer surface of the bushing; a ball movably disposed between the sliding groove and the guiding groove; a spindle penetrating the bushing, having an end protruding from the housing, and being coupled to the winding unit; and a resilient element disposed around the spindle and having an end coupled to the bushing.

3. The decelerating device of claim 2, wherein a working oil having a damping effect is filled between the sliding groove and the guiding groove.

4. The decelerating device of claim 2, wherein a positioning member is disposed at another end of the spindle and configured to protrude from the lid.

5. The decelerating device of claim 1, wherein the winding unit comprises: a connecting rod coupled to an end of the first decelerating unit, a spring disposed around the connecting rod, and a stopping member disposed at an end of the connecting rod.

6. The decelerating device of claim 1, wherein the second decelerating unit comprises: an outer sleeve; an inner sleeve disposed in the outer sleeve; an axle penetrating the outer and inner sleeves and protruding therefrom in lengthwise opposite directions; a resilient unit disposed around the axle and having an end coupled to the inner sleeve; and a stopping element disposed at an end of the axle, wherein the stopping element-disposed end of the axle protrudes from the inner sleeve.

7. The decelerating device of claim 6, wherein a positioning member is disposed at another end of the axle, wherein the positioning member-disposed end of the axle protrudes from the outer sleeve.

8. The decelerating device of claim 6, wherein a working oil having a damping effect is filled between the outer sleeve and the inner sleeve.
